(19) United States
(12) Patent Application Publication
(10) Pub. No.: US 2003/0033857 A1
(43) Pub. Date: Feb. 20, 2003

(54) Apparatus and method to detect leaks in sealed packages

(76) Inventor: Stephen H. Franks, Hopkinton, MA (US)

Correspondence Address: Donald W. Meeker, 750 La Playa, #512, San Francisco, CA, 94121, US

(21) Appl. No.: 10/222,515

(22) Filed: Aug. 16, 2002

Related U.S. Application Data
(60) Provisional application No. 60/312,896, filed on Aug. 16, 2001.

(51) Int. Cl. G01M 3/34; G01M 3/00

(52) U.S. Cl. 73/49.3; 73/52

(57) ABSTRACT

A laser displacement transducer mounted on an X-Y table below a vacuum chamber with a bottom glass window measures displacement in flexible surfaces of sealed packages to test for leakage. Sealed packages, including multi-chamber packages are positioned precisely in a grid pattern by rapid loading and unloading of the top of the vacuum chamber mounted on top of a console to permit using the device with an assembly line. Leaking cavities and packages are instantaneously identified by comparison of the measured displacement with programmed information about displacement and the results displayed on a screen. Leaking packages are discarded and well sealed packages are returned to the assembly line.

### CLAIM OF PROVISIONAL APPLICATION RIGHTS

This application claims the benefit of U.S. Provisional Patent Application No. 60/312,896 filed on Aug. 16, 2001.

### BACKGROUND OF THE INVENTION

1. Field of the Invention

This invention relates to a method and apparatus for testing containers, and in particular to a method and apparatus for testing the fluid tightness of sealed packages each having at least one flexible surface by placing the packages in a fast top loading vacuum chamber having a bottom window and applying a vacuum to the packages and measuring deformation of the flexible surfaces through the window by using a laser displacement transducer mounted on a motorized X-Y table below the vacuum chamber.

2. Description of the Prior Art

In many industries, it is important to test the fluid tightness of containers. For example, in the food industry, it is essential to ensure that containers in which foodstuffs are packed are completely sealed to ensure that the foodstuffs are in good condition, free from molds, bacteria and other pathogenic organisms, so that they will be safe when used by consumers. The pharmaceutical industry similarly requires that containers for medications such as pills or capsules or medical devices packaged in sterilized packages, be protected from contamination or serious danger to public health may result.

Various attempts have been made to provide apparatus for testing fluid tightness (hereinafter, for convenience, called “leak detection apparatus.”) Several forms of leak detection apparatus are known which do not rely on squeezing the container. In one form of such apparatus, the container to be tested is placed within a fluid tight chamber, the pressure within the chamber is changed from atmospheric to above or below atmospheric, and the effect of this pressure change on the container is monitored.

For example, U.S. Pat. No. 3,751,972 (Hass) describes a leak detector for testing sealed containers formed of semi-rigid or flexible material. The container to be tested is placed in a chamber which is thereafter pressurized at a pressure distinctly different from the internal container pressure, whereby the container is caused to physically distort. A container dimension is first sensed before the chamber is pressurized to produce a first signal representing the dimension resulting from the difference between container internal pressure and atmospheric pressure, this first signal being held. When the container is under pressure in the chamber and a predetermined time interval has elapsed, the container dimension is again sensed to produce a second signal representing the dimension as a result of the difference between internal pressure and chamber pressure. The first held signal and the second signal are compared and if the disparity therebetween indicates a significant change in dimension, the container is accepted, whereas if there is little disparity between the signals, the container is rejected.

Similarly, U.S. Pat. No. 5,105,654 (Maruyama et al.) describes an apparatus which is generally similar to that of Hass but in which at least a portion of the container being tested comprises an electrically conductive material, and the chamber is provided with an eddy-current displacement sensor to detect the position of the conductive material of the container.

U.S. Pat. No. 5,365,774 (Horlacher) also describes an apparatus which is generally similar to that of Hass but in which the chamber is equipped with a suction cup at the end of a suction pipe. This suction cup is placed above the flexible cover of the container being tested. When the pressure in the chamber is reduced, the cover bulges and blocks the suction cup. If the seal between the cover and the body of the container is ineffective, the lid does not bulge and block the cup, thus enabling the ineffective seal to be detected.

U.S. Pat. No. 5,513,516 (Stauffer) describes a method and apparatus in which a flexible or semi-flexible package is received within a closeable test cavity, and a pressure differential is established between the inside of the container and an enclosed space within the test cavity outside of the container. The closeable test cavity comprises a flexible wall whose shape adapts to the shape of the container, at least when the pressure differential is established. The flexible wall advantageously compensates for variations in head space and shape of the packages, as when the contents are not uniformly distributed within the package. The flexible wall can sealingly contact a portion of the container spaced from a container seal to permit detection of seal leaks. A gas permeable, flexible screen can be employed between the container and the flexible wall to permit leak detection of leaks in the container beneath the flexible wall.

Similarly, U.S. Pat. No. 4,055,984 (Marx) describes a device for detecting leaks in an article having readily deformable walls. This device has conventional arrangements for performing a leak detection by overpressure or by vacuum and has a deformable backup wall for engagement with the walls of the article. The backup wall is, on its face oriented towards the article, so configured that between the backup wall and the article there is obtained a coherent fluid tight space which may be evacuated.

The leak detection devices just described suffer from one serious problem when used in commercial settings. Food packages for retail sale, and similar relatively low cost packages, are normally filled on continuous packing lines which run at high speeds, typically at least 30 packages per minute, and it is highly desirable to conduct the leak detection procedure in-line with the packing line.

U.S. Pat. No. 4,774,830 (Hulsman) describes a leak detection apparatus which operates on a rather different principle from those previously described. The Hulsman apparatus is used in detecting defective flange-shaped seals between lid and body portions of a package. A pressure chamber is provided for isolating the external edge of the seal and applying a test pressure thereto. Containment of the pressure chamber includes sealing pressure applied mechanically to the flange-shaped package seal during testing. If the seal is defective, gas flows in one direction between the pressure chamber and interior of the package, thus causing a displacement of the lid of the package, and this displacement of the lid is detected by a position detector disposed adjacent a central portion of the lid, this central portion of the lid lying outside the pressure chamber and thus being maintained at ambient pressure. This Hulsman apparatus is effective in detecting leaks and better adapted than the apparatus previously discussed for use in-line with a packing line, since the Hulsman apparatus does not require removal of each package from the line and placement of the whole container within a pressure or vacuum chamber. The pressure chamber of the Hulsman apparatus is formed by two separate members which can close, clamshell style, on a package which is already resting on a transport conveyor or similar device. However, the Hulsman apparatus does require that the seal be placed within a pressure chamber. In addition, there is some risk of mechanical damage as a fragile lid is grasped between the members forming the pressure. Also, the process will not detect a leak located anywhere except in the lid sealing area, for example, in the lid or in the cup.

U.S. Pat. No. 4,803,868, issued Feb. 14, 1989 to Vinton, et al., discloses a method and apparatus for testing flexible sealed packages of the type wherein the package is at least partially made of a flexible, electrically conductive foil or metallic laminate wherein the capacitance between the flexible conductive foil or metallic laminated of the package and a fixed electrode is measured when the package is subjected externally to a partial vacuum. The apparatus includes an evacuable chamber adapted to support a package under test therewithin so that at least part of the flexible foil or metallic laminate portion of the package lies opposite said fixed electrode and a means for monitoring the capacitance between the electrode and that part of the foil or metallic laminate when the chamber is evacuated.

U.S. Pat. No. 6,330,823, issued Dec. 18, 2001 to Samuel O. Raymond, provides a method and process for checking the fluid tightness of containers having a first deformable section and a second deformable section spaced from the first deformable section by changing the pressure applied to the first deformable section, preferably without causing fluid to flow through the first deformable section out of the container, and without changing the pressure applied to the second deformable section, thereby causing a deformation of the first deformable section and a change in pressure within the container; and thereafter monitoring a predetermined characteristic, preferably the position, of the second deformable section. This process can be used to check the fluid tightness of the containers with relatively fragile seals, for example, a foil lid of a food container without mechanical contact. Automated apparatus for carrying out this process is described.

U.S. Pat. No. 4,055,984, issued Nov. 1, 1977 to Joachim Marx, shows a device adapted to detecting leaks in an article having readily deformable walls has conventional arrangements for performing a leak detection by overpressure or by vacuum and has a deformable backup wall for engagement with the walls of the article. The backup wall is, on its face oriented towards the article, so configured that between the backup wall and the article there is obtained a coherent fluidtight space which may be evacuated.

U.S. Pat. No. 4,747,299, issued May 31, 1988 to Fox, et al., claims a method of testing the integrity of a package seal provided between a container portion and a lid portion, includes the steps of: initially reducing the pressure acting on the outer surface of the container portion to cause the lid portion to bow inwardly to a position of substantially maximum concavity while maintaining the ullage volume within the package substantially constant; further reducing the pressure acting on the outer surface of the container portion to distend the container portion for increasing the volume of the ullage space; and sensing for a change in position of the distended container wall.

U.S. Pat. No. 4,117,718, issued Oct. 3, 1978 to Gary G. Hayward, describes an apparatus and method for monitoring the internal pressure or vacuum in a sealed container is provided which measures the amount of deflection of a flexible wall of the container as a function of the internal pressure. The apparatus provides a first electrical signal representative of the distance between a first point on the flexible wall and a first sensing means and a second electrical signal representative of the average of the distances between at least two other points of the flexible wall and second sensing means. The two signals are compared and a third signal indicative of the deflection of the flexible wall is provided.

There are other instruments on the market to discover leaks in small formed packages. The principal problems with the instruments are long cycle times and difficulty in setup for multiple package forms. Current products use contact sensors for displacement or force. Others use a surrogate chamber for displaced air from the package and measure pressure changes in the chamber.

None of the prior art devices provide an instantaneous non-contact means for detecting leaks operable with a rapid loading device capable of removing and replacing packages from an assembly line with the packages placed momentarily in a vacuum chamber of the device for instantaneous non-contact testing by a visual means outside of the vacuum chamber.

### SUMMARY OF THE INVENTION

It is a primary object of the present invention to provide an instantaneous non-contact means for detecting leaks operable with a rapid top loading device capable of removing and replacing sealed packages from an assembly line with the packages placed momentarily in a vacuum chamber for instantaneous non-contact testing by a visual means outside of the vacuum chamber.

A corollary object of the present invention is to provide a vacuum chamber with a rapid loading top and a glass bottom window and a laser displacement transducer mounted on a motorized X-Y platform below the vacuum chamber for instantaneous detection of any programmed amount of displacement in a flexible surface of the sealed packages thereby and accurately detecting leaks in sealed packages within the vacuum chamber.

A related object of the present invention is to provide the capability of detecting leaks in any cavity of a multi-cavity package by known placement of the package within the vacuum chamber and the accuracy of the X-Y motorized platform, so that the system is capable of pinpointing the exact cavity having a leak.

Another object of the present invention to provide an improved method and apparatus for testing the hermetic integrity of packages, in particular packages of the type which have a metal foil or multiple laminate materials as a flexible surface in the material of the package.

In brief, the leak detecting device will detect small leaks in sealed packages having a flexible surface, including plastic formed packages commonly used to dispense pharmaceutical solid dose medications, by sensing the displacement of the flexible surface of the package when it is exposed to a differential pressure with a non contact sensor. The sensitivity of measurement is enhanced by the use of a laser displacement transducer mounted on a motorized X-Y platform, the laser displacement transducer capable of being programmed to detect very small displacements for great accuracy. Further, the leaking individual cavity of a multi-cavity formed package can be identified. Further, the test can be performed with great accuracy in seconds.

The vacuum chamber has a bottom clear glass window and the laser displacement transducer on the X-Y platform is positioned below the vacuum chamber with the laser pointing up into the window leaving the top of the vacuum chamber free to function as a top loading vacuum chamber enabling rapid loading and unloading of the chamber conducive to operation with an assembly line. The information about cavities or packages having leaks is displayed on a front panel of a console on which the components are mounted.

The present invention is non contact and does not require specific manipulation of sensors to test a package. The product setup is from a software driven menu and will only require parametric input to enable the instrument. Further, the non contact sensor will make measurements within seconds of actuation. Further, the resolution of the sensor will permit the detection of smaller leaks in a shorter vacuum cycle time.

The system is capable of multiple package configuration use. The tested package is placed into a vacuum chamber that contains a pure glass bottom surface through which a laser light beam pointing upwardly from below can be passed with minimum distortion A vacuum pump will provide a specified level of vacuum in the chamber. The differential pressure between the inner package cavity and the vacuum chamber causes the package to expand. The package, being restrained on its edges will form a curved surface on its wall A laser displacement sensor, having been calibrated to the reference mounting plane of the package will sense the movement of the package wall. Package cavities that leak will not expand to the same amount as those with no leaks. The laser sensor will sweep the surface of the package using a motor driven X-Y table.

Programming will allow the specific measurement of each cavity of the package and display of leaking package cavities.

The elements of the tester are a vacuum pump, a laser displacement sensor, a motor driven X-Y carriage for the laser sensor, a vacuum chamber for retaining the tested package and containing a laser transparent window, and electronic controls and display of test results.

The vacuum chamber, called a cassette, holds the sealed package, which could be a pharmaceutical blister card to be on top of the measuring instrument. This location permits the present invention to work along side most package sealing production lines and move the blister cards from the line directly to the cassette. Since the measurement is non destructive, it is possible to open the cassette at the end of the test and replace the product on the packaging line.

Other applications of the present invention which lend themselves to this cassette vacuum chamber design include measuring sterile packages for the medical device industry and the food industry, packages that are made of films or foils which can be measured with the same technique by looking at a small area of the package (pouch) for changes in displacement when held in a restrained position, dry food or frozen food trays or standup pouches as well as packages that contain sterile medical devices.

A primary advantage of the present invention is that it provides an instantaneous non-contact means for detecting leaks operable with a rapid top loading device capable of removing and replacing sealed packages from an assembly line.

A corollary advantage of the present invention is that it provides a vacuum chamber with a rapid loading.

A related advantage of the present invention is that it provides the capability of detecting leaks in any cavity of a multi-cavity package so that the system is capable of pinpointing the exact cavity having a leak.

Another advantage of the present invention is that it provides an improved method and apparatus for testing the hermetic integrity of packages, in particular packages of the type which have a metal foil or laminate material as a flexible surface in the material of the package.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the console housing the leak detection apparatus showing the vacuum chamber package receiving cassette positioned on top of the console for fast loading and unloading of the packages;

FIG. 2 is a cross-sectional view taken through the vacuum chamber cassette of the apparatus of claim 1 showing a laser beam shining through clear glass on the bottom of the vacuum chamber cassette up to the bottom flexible foil layer of the pill containing packages being tested;

FIG. 3 is a partial perspective enlarged view of the vacuum chamber cassette of FIG. 1 showing the laser displacement sensor mounted on a motorized X-Y platform below the vacuum chamber cassette with the laser beam shining upward.

### BEST MODE FOR CARRYING OUT THE INVENTION

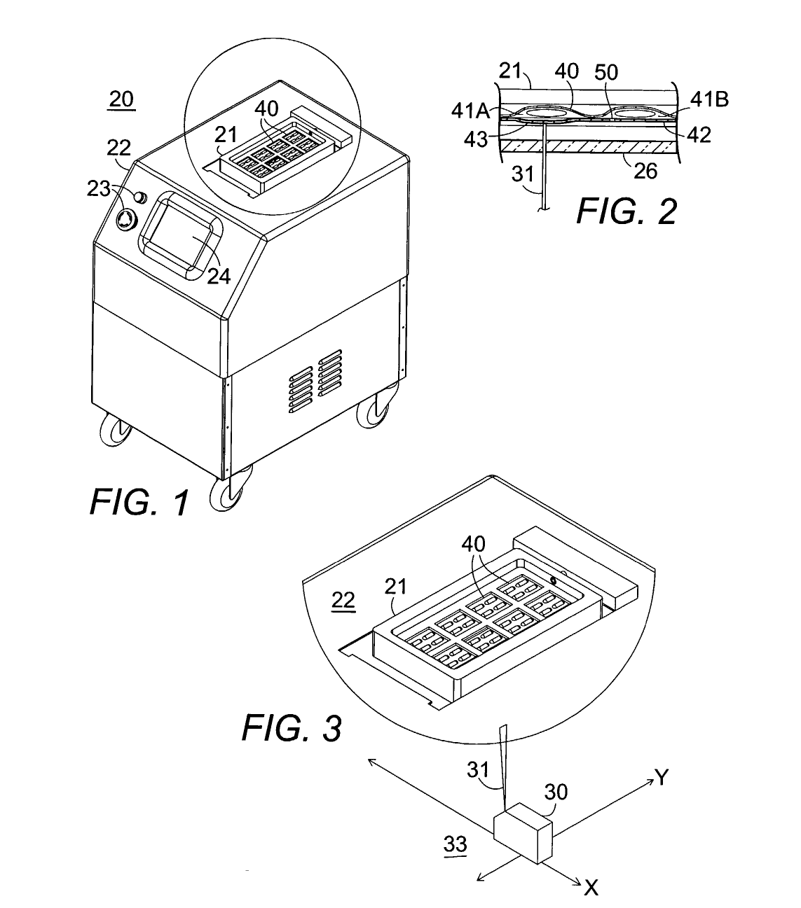

In FIGS. 1-3, a leak detector device 20 for detecting leaks in sealed packages 40 having a flexible surface, such as a foil surface 42, comprises a vacuum chamber 21 and a displacement detection means such as a laser displacement detection transducer 30.

The vacuum chamber 21 is capable of receiving at least one, and preferably a number of, sealed packages 40 each having at least one flexible surface, such as the foil surface 42. The vacuum chamber 21 (cassette) is also capable of applying a vacuum within the chamber surrounding the sealed packages 40. The vacuum chamber 21 has a means for visual contact with the sealed package 40 within the vacuum chamber, such as a clear glass window 26 suitable for a laser beam 31 without distortion on a bottom surface of the vacuum chamber, as seen in FIG. 2.

A displacement detection means, such as comprises a laser displacement transducer 30 capable of being programmed for instantaneous identification of any amount of displacement, utilizes a visual means, such as a laser beam 31, and is capable of detecting and measuring a displacement in the at least one flexible surface 42 through the glass window 26 and capable of reporting information about the displacement.

In FIG. 1, the vacuum chamber 21 is mounted externally on the leak detector device 20 on top of the console 22 housing the components of the device and is capable of receiving at least one, preferably a large number of, sealed packages 40 from a production line (not shown) for producing the at least one sealed package and capable of indicating the non-leaking sealed packages to be returned to the production line.

In FIG. 2 a sealed cavity 41A of a multi-cavity sealed package 40 is sealed tight with no leak, so the vacuum in the vacuum chamber 21 causes the flexible foil surface 42 to be displaced outwardly at the cavity, as shown by the bulge 43, from the pull of the vacuum. The laser beam 31 and laser displacement transducer 30 are used to detect and measure that displacement and report, if the displacement is sufficiently large according to a programmed comparative displacement benchmark, the instrument reports that there is no leak in the cavity and the package may be returned to the assembly line. However, when the laser encounters a cavity such as cavity 41B having a leak 50 in the flexible foil 42, the laser displacement transducer reports that there is little or no displacement and therefor a hole in the sealed package so that the package can be rejected.

In FIGS. 2 and 3, the laser displacement transducer 30 is mounted below the vacuum chamber 21 so that an upper portion of the vacuum chamber 21 is capable of loading and unloading a number of sealed packages 40 rapidly in conjunction with an assembly line (not shown) for sealing the packages. The laser displacement transducer 30 is mounted on a motor driven X-Y carriage 33 for programmed movement in relation to the glass window 26, as shown in FIG. 3.

Because of the positioning of the packages 40 within a grid system in the vacuum chamber 21 and the correlation of the laser displacement transducer 30 displacement readings in conjunction with the exact X-Y coordinates of the carriage, upon identification by the laser displacement transducer of a cavity displacement indicating a leak in the cavity, the specific location and therefore the specific leaking cavity and package can be identified.

In FIG. 1 on the console 22 control knobs 23 are used for the start and stop of the sequence and the touch screen display 24 allows the operator to input information and set up the system as well as act as a means for displaying information about the displacement.

In practice, a leak detector method for detecting leaks in sealed packages having a flexible surface comprises:

a first step of loading at least one, and preferably a number of, sealed packages 40 each having at least one flexible surface 42 into a vacuum chamber 21 capable of receiving the sealed packages therein and applying a vacuum within the chamber surrounding the sealed packages, the vacuum chamber 21 having a glass window 26 as a means for visual contact with the sealed packages 40 within the vacuum chamber 21; and

a second step of employing a laser displacement transducer 30 as a displacement detection means utilizing a laser beam 31 as a visual means for detecting and measuring a displacement in the flexible surfaces 42 of the packages 40 through glass window 26 and reporting information about the displacement.

The vacuum chamber 21, mounted externally on the leak detector device console 22, receives the sealed packages from a production line for producing the sealed packages and the laser displacement transducer 30, programmed for instantaneous displacement identification of any amount of displacement, measures the displacement and indicates the non-leaking sealed packages to be returned to the production line.

Because the glass window 26 is on a bottom surface of the vacuum chamber 21, a number of sealed packages are loaded and unloaded rapidly into a top portion of the vacuum chamber in conjunction with an assembly line for sealing the packages.

The laser displacement transducer 30 is mounted on a motor driven X-Y carriage 33 for programmed movement past the glass window 26 enabling the precise testing of multi-cavity formed packages 40 in the vacuum chamber 21 for identifying a leaking individual cavity, such as cavity 41B in FIG. 2, in one of the multi-cavity packages and pinpointing the exact X-Y coordinates of the carriage upon identification by the laser displacement transducer 30 of a cavity displacement indicating a leak in the cavity.

Information about the displacement is then displayed on a display means such as the screen 24 on the console 22.

It is understood that the preceding description is given merely by way of illustration and not in limitation of the invention and that various modifications may be made thereto without departing from the spirit of the invention as claimed.

What is claimed is:

1. A leak detector device for detecting leaks in sealed packages having a flexible surface, the device comprising:
a vacuum chamber capable of receiving at least one sealed package having at least one flexible surface and capable of applying a vacuum within the chamber surrounding the at least one sealed package, the vacuum chamber having a means for visual contact with the sealed package within the vacuum chamber;
a displacement detection means utilizing a visual means capable of detecting and measuring a displacement in the at least one flexible surface through the means for visual contact and capable of reporting information about the displacement.

2. The device of claim 1 wherein the vacuum chamber is mounted externally on the leak detector device and is capable of receiving at least one sealed package from a production line for producing the at least one sealed package and capable of indicating the non-leaking sealed packages to be returned to the production line.

3. The device of claim 2 wherein the displacement detection means comprises a laser displacement transducer capable of being programmed for instantaneous identification of any amount of displacement.

4. The invention of claim 3 wherein the means for visual contact is on a bottom surface of the vacuum chamber and the laser displacement transducer is mounted below the vacuum chamber so that an upper portion of the vacuum chamber is capable of loading and unloading a number of sealed packages rapidly in conjunction with an assembly line for sealing the packages.

5. The device of claim 3 wherein the vacuum chamber is capable of receiving at least one multi-cavity formed package and the laser displacement transducer is capable of identifying a leaking individual cavity in the multi-cavity package.

6. The device of claim 3 wherein the laser displacement transducer is mounted on a motor driven X-Y carriage for programmed movement past the means for visual contact.

7. The device of claim 6 further comprising a means for identifying the exact X-Y coordinates of the carriage upon identification by the laser displacement transducer of a cavity displacement indicating a leak in the cavity.

8. The device of claim 7 further comprising a means for displaying information about the displacement.

9. A leak detector method for detecting leaks in sealed packages having a flexible surface, the method comprising:
a first step of loading at least one sealed package having at least one flexible surface into a vacuum chamber capable of receiving the at least one sealed package therein and applying a vacuum within the chamber surrounding the at least one sealed package, the vacuum chamber having a means for visual contact with the sealed package, within the vacuum chamber;
a second step of employing a displacement detection means utilizing a visual means for detecting and measuring a displacement in the at least one flexible surface through the means for visual contact and reporting information about the displacement.

10. The method of claim 9 wherein the vacuum chamber is mounted externally on the leak detector device and further comprising the step of receiving at least one sealed package from a production line for producing the at least one sealed package and indicating the non-leaking sealed packages to be returned to the production line.

11. The method of claim 10 further comprising the step of using the displacement detection means comprising a laser displacement transducer programming it for instantaneous identification of any amount of displacement.

12. The method of claim 11 wherein the means for visual contact is on a bottom surface of the vacuum chamber and the laser displacement transducer is mounted below the vacuum chamber and further comprising the step of using an upper portion of the vacuum chamber for loading and unloading a number of sealed packages rapidly in conjunction with an assembly line for sealing the packages.

13. The method of claim 11 further comprising the step of receiving at least one multi-cavity formed package in the vacuum chamber and using the laser displacement transducer for identifying a leaking individual cavity in the multi-cavity package.

14. The method of claim 11 further comprising the step of operating the laser displacement transducer mounted on a motor driven X-Y carriage for programmed movement past the means for visual contact.

15. The method of claim 14 further comprising the step of identifying the location of a displacement by a means for identifying the exact X-Y coordinates of the carriage upon identification by the laser displacement transducer of a cavity displacement indicating a leak in the cavity.

16. The method of claim 15 further comprising the step of displaying information about the displacement on a display means.
